(19) United States
(12) Patent Application Publication
(10) Pub. No.: US 2025/0179677 A1
(43) Pub. Date: Jun. 5, 2025

(54) COMPOSITE MATERIAL, METHOD FOR PRODUCING THE COMPOSITE MATERIAL, AND TERMINAL

(71) Applicant: DOWA METALTECH CO., LTD., Tokyo (JP)

(72) Inventors: Tatsuhiro DOI, Tokyo (JP); Airi HIRAYAMA, Tokyo (JP); Hiroto NARIEDA, Tokyo (JP); Takao TOMIYA, Tokyo (JP); Hirotaka KOTANI, Tokyo (JP); Yukiya KATO, Tokyo (JP); Hirotaka TAKAHASHI, Tokyo (JP)

(73) Assignee: DOWA METALTECH CO., LTD., Tokyo (JP)

(21) Appl. No.: 18/843,811

(22) PCT Filed: Mar. 7, 2023
(86) PCT No.: PCT/JP2023/008583

§ 371 Date: Sep. 4, 2024

(30) Foreign Application Priority Data
Mar. 10, 2022 (JP) 2022-037084
Mar. 2, 2023 (JP) 2023-031966

(51) Int. Cl. C25D 3/46; C25D 7/00; C25D 15/00

(52) U.S. Cl. CPC C25D 3/46; C25D 7/00; C25D 15/00

(57) ABSTRACT

There is provided a composite material, that is a composite material in which a composite coating composed of a silver layer containing carbon particles is provided on a base material, wherein a crystallite size of silver of the composite coating is 30 nm or less; a value obtained by dividing an arithmetic average roughness Ra (μm) of the composite coating by a thickness (μm) of the composite coating is less than 0.2; and a proportion of carbon particles on a surface of the composite coating is 5% by area or more and 80% by area or less.

### TECHNICAL FIELD

The present invention relates to a composite material in which a predetermined composite coating is provided on a base material, a method for producing the same, etc., and particularly, relates to a composite material used as a material for sliding electrical contact parts such as switches and connectors, and a method for producing the same.

### DESCRIPTION OF RELATED ART

Conventionally, a silver (Ag) plated material with silver plating applied to a conductive material, is used as a material for sliding electrical contact parts such as switches and connectors, to prevent oxidation of the conductive material such as copper (Cu) and a copper alloy due to heating during a sliding process.

However, silver plating is soft and easily worn, and generally has a high friction coefficient, thus involving a problem that it easily peels off due to sliding. In order to solve this problem, there is a method of improving wear resistance by providing a composite material with a coating provided on a conductive material by electrical plating, the coating being a composite coating in which graphite particles of carbon particles such as graphite and carbon black that have excellent heat resistance, wear resistance and lubricity, are dispersed in a silver matrix (for example, see Patent documents 1 and 2).

Further, Patent document 3 discloses a silver-plated material with excellent heat resistance, wear resistance and bending workability, in which a first silver-plated layer having a specific crystal orientation and a second silver-plated layer having a Vickers hardness of 140 or more are formed in this order on a base material.

By performing research for the purpose of providing a composite material with excellent wear resistance, and executing electroplating using a silver plating solution containing specific components, the present applicant came up with an idea of a composite coating (AgC layer) having a small crystallite size and therefore high hardness and excellent wear resistance, and disclosed this composite coating in Patent document 4.

### PRIOR ART DOCUMENT

### Patent Document

[Patent Document 1] Japanese Patent No. 3054628
[Patent Document 2] Japanese Patent No. 4806808
[Patent Document 3] Japanese Patent No. 5848168
[Patent Document 4] WO2021/261066 Brochure

### SUMMARY OF THE INVENTION

### Problem to be Solved by the Invention

As described above, the composite coating disclosed in Patent document 4 has excellent wear resistance.

However, further investigation by the present inventors revealed that in the technique disclosed in Patent document 4, many nodular electrodeposition structures considered to be made of silver are generated on the surface of the composite coating. The nodules are weakly bonded to a surrounding portion (a silver matrix that constitutes the composite coating) and may easily shed due to an external stress, and therefore there is a risk of them contaminating the equipment when the composite material is used (e.g., during bending).

The present invention has been made under the above circumstances, and the problem to be solved by the present invention is to provide a composite material in which a composite coating containing carbon particles in a silver layer is provided on a base material, that is a composite material that has excellent wear resistance and prevents silver from shedding from the composite coating (AgC layer) during bending, and to provide a method for producing the same, and a terminal for electrical contacts using the composite material. In this specification, “excellent wear resistance” means high hardness and low friction coefficient.

### Means for Solving the Problem

The present inventors have studied the cause of the development of the above-described nodules. When a composite coating is formed by electroplating using a silver plating solution containing carbon particles, the carbon particles become entrapped in a silver matrix. When the silver plating solution contains a specific additive (a benzoic acid-based compound) as in Patent document 4, it is considered that plating proceeds with the additive adsorbed on the carbon particles. The development of the nodules is considered as follows: on the surface of the composite coating being formed, carbon particles are present that are entrapped in the silver matrix but are partially exposed, and the additive is adsorbed on these carbon particles, and Ag precipitates at exposed portions of the carbon particles where the additive is adsorbed, resulting in growing and forming nodules. Normally, Ag precipitates on Ag that is a silver matrix being formed, but it is considered that the additive adsorbed on the carbon particles becomes a starting point for Ag precipitation.

Based on the above finding, the present inventors have come up with an idea that the composite material having fewer nodules on the surface can be produced by subjecting a carbon particle surface to a specific modification (this is considered to be due to the suppression of Ag precipitation on the carbon particles entrapped in the silver matrix). Thus, the present invention is completed.

That is, in order to solve the above-described problem, the first invention provides a composite material, that is a composite material in which a composite coating composed of a silver layer containing carbon particles is provided on a base material,
wherein a crystallite size of silver of the composite coating is 30 nm or less;
a value obtained by dividing an arithmetic average roughness Ra (μm) of the composite coating by a thickness (μm) of the composite coating is less than 0.2; and
a proportion of the carbon particles on a surface of the composite coating is 5% by area or more and 80% by area or less.

The second invention provides the composite material according to the first invention, wherein the base material is composed of Cu or a Cu alloy.

The third invention provides the composite material according to the first or second invention, wherein the surface of the composite coating has a Vickers hardness of 100 or more.

The fourth invention provides the composite material according to any one of the first to third inventions, wherein the thickness of the composite coating is 0.5 μm or more and 45 μm or less.

The fifth invention provides the composite material according to any one of the first to fourth inventions, wherein the composite coating has an arithmetic average roughness Ra of 1.8 μm or less.

The sixth invention provides the composite material according to any one of the first to fifth inventions, wherein a crystallite size of silver of the composite coating is 2 to 20 nm.

The seventh invention provides the composite material according to any one of the first to sixth inventions, wherein an underlayer selected from Cu, Ni, Sn, and Ag is provided between the base material and the composite coating.

The eighth invention provides a method for producing a composite material, including:
electroplating in a silver plating solution containing carbon particles to form a composite coating composed of a silver layer containing the carbon particles on a base material,
wherein the carbon particles are surface-treated with a polymer, and
the silver plating solution contains the surface-treated carbon particles and a compound A represented by the following general formula (I),

### [Chemical Formula 1]

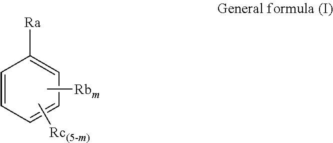

in the general formula (I), m is an integer from 1 to 5;
Ra is a carboxyl group;
Rb is an aldehyde group, a carboxyl group, an amino group, a hydroxyl group, or a sulfonic acid group; and
Rc is hydrogen or an arbitrary substituent;
when m is 2 or more, a plurality of Rb's may be the same or different;
when m is 3 or less, a plurality of Rc's may be the same or different; and
Ra and Rb may each independently be bonded to a benzene ring via a divalent group composed of at least one selected from a group consisting of —O— and —CH₂—.

The nineth invention provides the method for producing a composite material according to the eighth invention of the present invention, wherein the polymer is a cationic polymer, an anionic polymer or a nonionic polymer.

The tenth invention provides the method for producing a composite material according to the nineth invention, wherein the cationic polymer is at least one selected from a group consisting of poly(diallyldimethylammonium chloride) and diallylamine hydrochloride-acrylamide copolymer.

The eleventh invention provides the method for producing a composite material according to the nineth or tenth invention, wherein a weight average molecular weight of the cationic polymer is 1,000 or more and 150,000 or less.

The twelfth invention provides the method for producing a composite material according to the nineth invention, wherein the anionic polymer is a polyhydric phenol condensate derivative, and the condensate derivative has a hydroxyl group and a sulfo group.

The thirteenth invention provides the method for producing a composite material according to the nineth or twelfth invention, wherein a weight average molecular weight of the anionic polymer is 1,000 or more and 50,000 or less.

The fourteenth invention provides the method for producing a composite material according to the nineth invention, wherein the nonionic polymer is polyacrylamide.

The fifteenth invention provides the method for producing a composite material according to the nineth or fourteenth invention, wherein a weight average molecular weight of the nonionic polymer is 1,000 or more and 10,000,000 or less.

The sixteenth invention provides the method for producing a composite material according to any one of the eighth to fifteenth inventions, wherein an amount of the polymer used per 100 parts by mass of the carbon particles is 10 to 150 parts by mass.

The seventeenth invention provides the method for producing a composite material according to any one of the eighth to sixteenth inventions, wherein a concentration of the carbon particles in the silver plating solution is 10 g/L or more and 150 g/L or less.

The eighteenth invention provides the method for producing a composite material according to any one of the eighth to seventeenth inventions, wherein a surface treatment of the carbon particles is performed by stirring and mixing the carbon particles in water in a presence of the polymer.

The nineteenth invention provides the method for producing a composite material according to any one of the eighth to eighteenth inventions, wherein the base material is composed of Cu or a Cu alloy.

The twentieth invention provides a terminal for electrical contacts, the terminal comprising the composite material according to any one of the first to seventh inventions as a constituent material.

### Advantage of the Invention

According to the present invention, there is provided a composite material in which a composite coating containing carbon particles in a silver layer is provided on a base material, the composite material having excellent wear resistance and suppressing silver from shedding from the composite coating during bending, and is provided a method for producing the composite material, and is provided a terminal for electrical contacts using the composite material.

### BRIEF DESCRIPTION OF THE DRAWINGS

FIG. 1 is a schematic cross-sectional view illustrating a test for evaluating silver shedding during bending in an example.

FIG. 2 shows laser microscope photographs of plated coatings in the composite materials produced, and backscattered electron image photographs of silver on a carbon tape after peeling, in Examples 2 and 3 and Comparative Examples 1 and 4.

### DETAILED DESCRIPTION OF THE INVENTION

Hereinafter, an embodiment of the present invention will be described.

### [1. Method for Producing a Composite Material]

According to an embodiment of the present invention, there is provided a method for producing a composite material, in which a composite coating containing carbon particles in a silver layer is provided on a base material by electroplating in a specific silver plating solution containing carbon particles that have been subjected to a specific surface treatment. Each step of the manufacturing method of this composite material will be described hereafter.

### <<1-1. Base Material>>

The constituent material of the base material on which the composite coating is provided, is preferably the one that can be plated with silver and has an electrical conductivity required for sliding contact parts such as switches and connectors, and further, from a viewpoint of a cost, Cu (copper) and Cu alloys are preferable as the constituent material of the base material. As the Cu alloy, from the viewpoints of electrical conductivity, strength, etc., an alloy composed of Cu, and at least one selected from the group consisting of Si (silicon), Fe (iron), Mg (magnesium), P (phosphorus), Ni (nickel), Sn (tin), Co (cobalt), Zn (zinc), Be (beryllium), Pb (lead), Te (tellurium), Ag (silver), Zr (zirconium), Cr (chromium), Al (aluminum) and Ti (titanium), and inevitable impurities is preferable. An amount of Cu in the Cu alloy is preferably 85% by mass or more, more preferably 92% by mass or more (the amount of Cu is preferably 99.95% by mass or less).

The base material is preferably used in a terminal application (as a composite material with which a composite coating is provided) as described below, and the base material itself may have a shape for that application, or the base material may be flat (such as a plate) and is then molded into a desired shape as a composite material in some cases. In order to obtain the effects of the present invention, the base material preferably has a flat shape.

### <<1-2. Formation of an Underlayer>>

In the method for producing a composite material of the present invention, an underlayer may be formed on the base material, and the underlayer may be electroplated as described below. The underlayer is formed for the purpose of preventing the copper of the base material from diffusing onto a plating surface to be oxidized, which deteriorates a contact reliability of the composite material, and for the purpose of improving an adhesion of the composite coating. Constituent metals of the underlayer include Cu, Ni, Sn and Ag. The underlayer may be a layer composed of Cu, Ni, Sn, or Ag, or a layer composed of a combination of these (a laminate structure), and the underlayer may be formed on an entire surface of the base material or on only a part of it, depending on the application of the composite material to be produced.

There is no particular limitation in the method for forming the underlayer, and the underlayer can be formed by electroplating using a plating solution containing ions of the above-described constituent metals by a known method. From a viewpoint of a wastewater treatment cost, it is preferable that the plating solution does not substantially contain a cyanide compound.

### <<1-3. Ag Strike Plating>>

Before forming the composite coating on the base material, it is preferable to form a very thin intermediate layer by Ag strike plating to improve adhesion between the base material and the composite coating. When the underlayer is formed on the base material, it is preferable to perform Ag strike plating on the underlayer to improve adhesion between the underlayer and the composite coating. As a method for performing Ag strike plating, any conventionally known method can be used without particular limitation as long as it does not impair the effects of the present invention. It is preferable that the plating solution used in Ag strike plating does not substantially contain a cyanide compound in terms of a wastewater treatment cost.

### <<1-4. Electroplating>>

The method for producing a composite material of the present invention is as follows: in a specific silver plating solution, electroplating is performed to the above-described base material after forming an underlayer and/or an intermediate layer by Ag strike plating as necessary, to form a composite coating on the base material that contains carbon particles in a silver layer.

### <1-4-1. Silver Plating Solution>

The silver plating solution contains silver ions, a specific compound A, and carbon particles.

### (1-4-1-1. Silver Ions)

The silver plating solution contains silver ions. The silver concentration in the silver plating solution is preferably 5 to 150 g/L, more preferably 10 to 120 g/L, and most preferably 20 to 100 g/L from the viewpoints of the rate of formation of the composite coating and of suppressing unevenness in the appearance of the composite coating.

### (1-4-1-2. Compound A)

Next, a compound A is represented by the following general formula (I).

[Chemical formula 2]

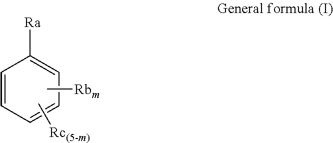

In the general formula (I), m is an integer of 1 to 5; Ra is a carboxyl group; Rb is an aldehyde group, a carboxyl group, an amino group, a hydroxyl group, or a sulfonic acid group; Rc is hydrogen or an arbitrary substituent; Ra and Rb may each independently be bonded to a benzene ring via a divalent group composed of at least one selected from the group consisting of —O— and —CH₂—. Examples of the divalent group include —CH₂—CH₂—O—, —CH₂—CH₂—CH₂—O—, and (—CH₂—CH₂—O—)ₙ (n is an integer of 2 or more).

It is considered that the compound A is adsorbed onto the surface of deposited silver and inhibits the growth of silver crystals, thereby reducing a crystallite size of silver of the composite coating formed by electroplating. This results in a composite material with excellent hardness and therefore excellent wear resistance.

Further, in the above-described general formula (I), when m is 2 or more, a plurality of Rb's may be the same or different, and when m is 3 or less, a plurality of Rc's may be the same or different. Regarding Rc, the “arbitrary substituent” includes an alkyl group having 1 to 10 carbon atoms, an alkylaryl group, an acetyl group, a nitro group, a halogen group, and an alkoxyl group having 1 to 10 carbon atoms.

The concentration of the compound A in the silver plating solution is preferably 2 to 250 g/L, and more preferably 3 to 200 g/L, from the viewpoints of suppressing unevenness in the appearance of the composite coating and appropriately controlling the crystallite size of silver in the composite coating being formed.

### (1-4-1-3. Carbon Particles)

Next, the silver plating solution contains carbon particles. When the silver plating solution contains carbon particles, the carbon particles are entrapped in a silver matrix when the composite coating (silver plating film) is formed on a base material by electroplating. The inclusion of carbon particles in the composite coating increases the wear resistance of the composite material. From the viewpoint of exerting such a function, the carbon particles are preferably graphite particles. The carbon particles preferably have a volume-based cumulative 50% particle size (D50) of 0.5 to 15 μm, further preferably 1 to 10 μm as measured by a laser diffraction/scattering particle size distribution measuring device, from the viewpoint of ease of inclusion in the silver plating film. Further, the shape of the carbon particles is not particularly limited and may be substantially spherical, flaky, or amorphous. However, a flaky shape is preferable because it can improve the wear resistance of the composite material by smoothing the surface of the composite coating.

### (1-4-1-3-1. Oxidation Treatment of Carbon Particles)

Further, it is preferable to remove lipophilic organic compounds adsorbed on the surface of the carbon particles by subjecting the carbon particles to an oxidation treatment. Such lipophilic organic compounds include aliphatic hydrocarbons such as alkanes and alkenes, and aromatic hydrocarbons such as alkylbenzenes. As the oxidation treatment of the carbon particles, in addition to a wet oxidation treatment, a dry oxidation treatment using O₂ gas, etc., can be used. However, from the viewpoint of mass productivity, it is preferable to use the wet oxidation treatment. Carbon particles with a large surface area can be uniformly treated by the wet oxidation treatment. As a method for the wet oxidation treatment, a method of suspending carbon particles in water and then adding an appropriate amount of an oxidizing agent can be used. The oxidizing agent that can be used includes nitric acid, hydrogen peroxide, potassium permanganate, potassium persulfate, sodium perchlorate, etc. It is considered that the lipophilic organic matter adhering to the carbon particles is oxidized by the added oxidizing agent to become easily soluble in water, and is then appropriately removed from the surface of the carbon particles. Filtration and further washing of the carbon particles with water after the wet oxidation treatment can further enhance the effect of removing the lipophilic organic matter from the surface of the carbon particles. By the oxidation treatment of the carbon particles, lipophilic organic compounds such as aliphatic and aromatic hydrocarbons can be removed from the surface of the carbon particles, and according to the analysis using 300° C. heated gas, the gas generated by heating the carbon particles after the oxidation treatment at 300° C. contains almost no lipophilic aliphatic hydrocarbons such as alkanes and alkenes, or lipophilic aromatic hydrocarbons such as alkylbenzenes. Even when the carbon particles after oxidation treatment contain small amounts of aliphatic or aromatic hydrocarbons, the carbon particles can be uniformly dispersed in the silver plating solution used in the present invention, but it is preferable that the carbon particles do not contain any hydrocarbons having a molecular weight of 160 or more, and that the intensity of the gas evolved from hydrocarbons having a molecular weight of less than 160 in the carbon particles when heated at 300° C. (intensity determined by purge and trap gas chromatography mass spectrometry) is 5,000,000 or less.

### (1-4-1-3-2. Surface Treatment of Carbon Particles)

When electroplating, which will be described later, is performed using carbon particles that have been subjected to the above-described oxidation treatment as necessary, as described in the section [Means for solving the problem], many nodular electrodeposition structures are generated on the surface of the composite coating, increasing the arithmetic average roughness Ra of the coating surface (the thicker the coating, the larger and more numerous the nodules become, and the higher the Ra tends to be.) The nodules are weakly bonded to the surrounding silver matrix and can easily fall off due to an external stress.

In the present invention, the carbon particles are surface-treated with a polymer. It is considered that this suppresses the adsorption of plating solution components such as a compound A of general formula (I) described below onto the carbon particles, and suppresses the deposition of Ag on the carbon particles, forming a composite coating with fewer surface nodules (and therefore less silver shedding during bending). The polymers include cationic polymers, anionic polymers, nonionic polymers and amphoteric polymers. The surface treatment may be performed using one of these polymers, or two or more of them in combination.

The surface treatment of the carbon particles is performed, for example, as follows. Carbon particles, which have been subjected to an oxidation treatment as necessary, are mixed with stirring in water in the presence of a polymer. At this time, it is considered that the hydrophobic portion of the polymer is attracted to the portion of the carbon particle that does not have surface functional groups, while the hydrophilic portion (=hydrophilic functional groups such as hydroxyl groups, etc.) of the polymer is attracted to the portion of the carbon particle that has surface functional groups, resulting in the polymer being adsorbed onto the carbon particle. After the stirring and mixing, filtration is performed and washing may be performed for the filtered product (carbon particles surface-treated with polymer) with water. In this way, it is considered that the polymer adheres to the surface of the carbon particles.

The weight average molecular weight of a cationic polymer (weight average molecular weight measured by GPC in terms of standard polyethylene glycol and standard polyethylene oxide) is preferably 1,000 or more and 150,000 or less. From the viewpoint of preventing silver from shedding during bending, the weight average molecular weight is more preferably 1,100 or more and 80,000 or less, and further, it is particularly preferable that the weight average molecular weight is 1200 or more and 6000 or less, and particularly preferable that the electroplating conditions described below are such that the thickness of the formed composite coating is 0.5 to 10 μm.

An example of the cationic functional group of the cationic polymer is an ammonium group. Further, specific examples of the cationic polymer include poly(diallyldimethylammonium chloride) and diallylamine hydrochloride-acrylamide copolymer, and from the viewpoint of preventing silver from shedding during bending, poly(diallyldimethylammonium chloride) is preferable.

The weight average molecular weight (measured by GPC) of the anionic polymer is preferably 1,000 or more and 50,000 or less. From the viewpoint of preventing silver from shedding during bending, the weight average molecular weight is more preferably 1,200 or more and 30,000 or less, and particularly preferably 1,500 or more and 10,000 or less.

Examples of the anionic functional group of the anionic polymer include a hydroxyl group, a sulfo group, and a carboxyl group. Further, specific examples of the anionic polymer include a polyhydric phenol condensate derivative (having a hydroxyl group and a sulfo group).

The weight average molecular weight (measured by GPC) of the nonionic polymer is preferably 1,000 or more and 10,000,000 or less. From the viewpoint of preventing silver from shedding during bending, the weight average molecular weight is more preferably 2,000 or more and 5,000,000 or less, and particularly preferably 10,000 or more and 3,000,000 or less.

Specific examples of nonionic polymers include polyacrylamide and polymethacrylamide.

The weight average molecular weight (measured by GPC) of the amphoteric polymer is preferably 1,000 or more and 10,000,000 or less. From the viewpoint of preventing silver from shedding during bending, the weight average molecular weight is more preferably 2,000 or more and 5,000,000 or less, and particularly preferably 10,000 or more and 3,000,000 or less.

The amphoteric polymer is a polymer having a cationic functional group and an anionic functional group, and examples of the functional groups are the same as those in the cationic polymer and the anionic polymer. Further, specific examples of the amphoteric polymer include acrylamide/dimethylaminoethyl acrylate quaternary salt/sodium acrylate copolymers and methacrylamide/dimethylaminoethyl methacrylate quaternary salt/sodium methacrylate copolymers.

When the carbon particles are surface-treated (when the carbon particles are stirred and mixed in water in the presence of a polymer), the concentration of the carbon particles in the water is preferably 200 g/L or less (usually 10 g/L or more. More preferably, 50 to 120 g/L). The amount of polymer used per 100 parts by mass of carbon particles (when a plurality of types of polymers is used, the total amount used) is preferably 10 to 150 parts by mass (more preferably, 20 to 100 parts by mass), and a liquid temperature is preferably 15° C. or higher and 60° C. or lower, and a surface treatment (stirring and mixing) time is preferably 3 hours or longer and 30 hours or shorter. Washing with water may be performed until the electrical conductivity of a filtrate becomes 10 μS/cm or less.

Further, from the viewpoint of the wear resistance of the composite material obtained by forming a composite coating on a base material using a silver plating solution, and since the amount of carbon particles that can be introduced into the composite coating is limited, the amount of the carbon particles surface-treated with polymer in the silver plating solution is preferably 10 g/L or more and 150 g/L or less, more preferably 15 g/L or more and 120 g/L or less, and most preferably 30 g/L or more and 100 g/L or less.

### (1-4-1-4. Complexing Agent)

The silver plating solution used in the present invention preferably contains a complexing agent. The complexing agent complexes the silver ions in the silver plating solution, thereby enhancing the stability of the ions. This action increases the solubility of silver in a solvent that constitutes the plating solution.

A wide variety of complexing agents having the above-described functions can be used, but from the viewpoint of the stability of the formed complex, a compound having a sulfonic acid group are preferable. Examples of the compounds having a sulfonic acid group include alkylsulfonic acids having 1 to 12 carbon atoms, and alkanolsulfonic acids and hydroxyarylsulfonic acids having 1 to 12 carbon atoms. Specific examples of these compounds include methanesulfonic acid, 2-propanolsulfonic acid, and phenolsulfonic acid.

The amount of the complexing agent in the silver plating solution is preferably 30 to 200 g/L, and more preferably 50 to 120 g/L, from the viewpoint of stabilizing silver ions.

### (1-4-1-5. Other Additives)

As other additives, for example, the silver plating solution used in the present invention may contain brighteners, hardeners, and conductive salts. Examples of the hardeners include carbon sulfide compounds (such as carbon disulfide), inorganic sulfur compounds (such as sodium thiosulfate), organic compounds (sulfonates), selenium compounds, tellurium compounds, and metals from group 4B or 5B of the periodic table.

### (1-4-1-6. Solvent)

The solvent constituting the silver plating solution is mainly water. Water is preferable because it has excellent solubility for (complexed) silver ions and other components contained in the plating solution, and it places little strain on the environment. Further, a mixed solvent of water and alcohol may be used as the solvent.

### (1-4-1-7. Cyanide Compound)

The main components of the silver plating solution used in the present invention are as described above, and the silver plating solution typically does not substantially contain a cyanide compound (specifically, the content of cyanide compound in the silver plating solution is 1 mg/L or less.). The cyanide compound is a compound that contains a cyano group (—CN), and the amount of the cyanide compound can be quantified in accordance with JIS K0102:2019. The cyanide compound is subject to the Water Pollution Control Law (effluent standards) and the PRTR (Pollutant Release and Transfer Register) system, and therefore incur a large wastewater treatment cost. As described above, the silver plating solution used in the present invention typically contains substantially no cyanide compounds, and therefore incur a small wastewater treatment cost.

### <1-4-2. Electroplating Conditions>

Next, various conditions for electroplating using the above-described silver plating solution will be described. For example, by electroplating as described below, metal silver is deposited on the base material, and the polymer-surface-treated carbon particles become entrapped in the silver matrix, thereby forming a composite coating. Further, due to the function of the compound A, the crystallite size of silver in the composite coating is kept small. Further, the effect of the polymer also suppresses the occurrence of nodules.

### (1-4-2-1. Cathode and Anode)

The base material to be electroplated is a cathode, and for example a silver electrode plate that dissolves to provide silver ions, is an anode.

### (1-4-2-2. Current Density)

The cathode and the anode are immersed in the silver plating solution (plating bath), and a current is passed through them to perform silver plating. A current density here is preferably 0.5 A/dm² or more and 10 A/dm² or less, more preferably, 1 A/dm² or more and 8 A/dm² or less, and even more preferably, 1 A/dm² or more and 5 A/dm² or less, from the viewpoint of the formation rate of the composite coating and the viewpoint of suppressing unevenness in the appearance of the composite coating.

### (1-4-2-3. Temperature, Stirring, Plating Time, Plating Target Area)

The temperature of the plating bath (silver plating solution) during electroplating (plating temperature) is preferably 15 to 50° C., more preferably 20 to 45° C., from the viewpoints of plating production efficiency and preventing excessive evaporation of the solution. In this case, the stirring speed of the plating bath is preferably 200 to 550 rpm, and more preferably 350 to 500 rpm, from the viewpoint of performing uniform plating. The silver plating time (time for applying electric current) can be appropriately adjusted depending on a target thickness of the composite coating, but is typically in the range of 25 to 1800 seconds. An area to be plated may be an entire surface layer of the base material or a part of the surface layer of the base material, depending on the application of the composite material to be produced.

<<1-5. Treatment for Partially Removing Carbon Particles from the Surface of the Composite Coating>>

By the electroplating described above, the composite coating is formed on the base material. In the surface of this composite coating, there are carbon particles that are entrapped and embedded in the silver matrix and are difficult to shed, and carbon particles that are adhered to the surface rather than being entrapped in the silver matrix and are therefore more likely to shed. The latter can contaminate equipment, for example during bending of the composite material. Therefore, it is preferable to remove such carbon particles by washing. One washing method is to subject the surface of the composite coating to ultrasonic cleaning. The ultrasonic cleaning is preferably performed at 20 to 100 kHz for 1 to 300 seconds. Another cleaning method is electrolytic cleaning. In this case, the electrolytic cleaning is preferably performed at 1 to 30 A/dm² for 10 to 300 seconds.

### [2. Composite Material]

Hereinafter, an embodiment of the composite material of the present invention will be described. The composite material is a composite material in which a composite coating containing carbon particles in a silver layer is provided on a base material, that is a composite material in which the crystallite size of silver of the composite coating is 30 nm or less, the arithmetic average roughness Ra (μm) of the surface of the composite coating divided by the thickness (μm) of the composite coating is less than 0.2, and the proportion of carbon particles in the surface of the composite coating is 5 area % or more and 80 area % or less. This composite material can be produced, for example, by the method for producing a composite material of the present invention. Each component of this composite material will be described below.

### <<2-1. Base Material>>

The base material is similar to those described above for the method of producing a composite material of the present invention. That is, Cu (copper) and a Cu alloy are suitable as the constituent materials of the base material, and the Cu alloy is preferably an alloy made of Cu, and at least one selected from the group consisting of Si (silicon), Fe (iron), Mg (magnesium), P (phosphorus), Ni (nickel), Sn (tin), Co (cobalt), Zn (zinc), Be (beryllium), Pb (lead), Te (tellurium), Ag (silver), Zr (zirconium), Cr (chromium), Al (aluminum) and Ti (titanium) and inevitable impurities, from the viewpoint of electrical conductivity and strength.

### <<2-2. Composite Coating>>

The composite coating formed on the base material is composed of a silver layer containing carbon particles. In this silver layer, the carbon particles are dispersed (preferably substantially uniformly) in a matrix composed of silver. When Ag strike plating is performed before forming the composite film, an intermediate layer resulting from this strike plating layer exists between the base material (or the underlayer described below) and the composite coating, but in many cases it is so thin that it cannot be distinguished from the composite coating. The composite coating may be formed on an entire surface, or on only a portion of the surface of the base material.

### <2-2-1. Carbon Particles>

The carbon particles are similar to the carbon particles subjected to surface treatment with polymer described above for the method for producing a composite material of the present invention. That is, the carbon particles are preferably graphite particles, and the shape thereof is not particularly limited and may be substantially spherical, flaky, or amorphous, but a flaky shape is preferable because the wear resistance of the composite material can be improved by making the surface of the composite coating smooth. When the composite material of the present invention is produced by the method for producing a composite material of the present invention, it is considered that the polymer is adhered to the surface of the carbon particles.

From the viewpoint of the wear resistance of the composite material, an average primary particle size of the carbon particles is preferably 0.5 to 15 μm, and more preferably 1 to 10 μm. An average primary particle size is an average value of a long diameter of the particles, and the long diameter is defined as a length of a longest line segment that can be drawn within a particle in an image (flat surface) of a carbon particle in the composite coating of the composite material observed at an appropriate observation magnification. The long diameter is obtained for 50 or more particles.

### <2-2-2. Crystallite Size and Vickers Hardness>

The crystallite size of silver in the composite coating in the embodiment of the composite material of the present invention is as small as 30 nm or less. Such a small crystallite size results in a high hardness of the composite coating due to a Hall-Petch relationship (generally, the smaller the crystal grains of a metal material, the stronger it is), and the high hardness makes the composite coating less susceptible to abrasion, thereby increasing the wear resistance of the composite material. From the viewpoint of the wear resistance and due to difficulty in production to make the crystallite size very fine, the crystallite size is preferably 2 to 30 nm, more preferably 2 to 20 nm.

In the present invention, the crystallite size of silver is determined by averaging (adding up and dividing by 2) the crystallite sizes of the silver (111) and (222) planes in order to reduce bias due to the crystal plane. A more detailed method for measuring the crystallite size will be described in the Examples.

As described above, the composite coating has a small crystallite size and is therefore hard, and specifically, the Vickers hardness Hv thereof is preferably 100 or more, and more preferably 120 to 230. The method for measuring the Vickers hardness Hv will be described in detail in the Examples.

### <2-2-3. Ratio of the Arithmetic Average Roughness Ra to the Thickness of Composite Coating>

As described above, the crystallite size of silver of the composite coating of the composite material of the present invention is small, and the coating achieves high hardness. To achieve such a small crystallite size, it is essential to use a silver plating solution containing a compound A during electroplating to form a composite film. However, as described in the section [Means for solving the problem], this compound A causes the formation of a nodular electrodeposition structure on the surface of the composite coating. As a result, the arithmetic average roughness Ra (μm) of the composite coating increases. The thicker the composite coating, the more likely the nodules are to occur and the larger they become, resulting in a larger Ra of the composite coating.

In the method for producing a composite material of the present invention, the occurrence of the above-described nodules can be suppressed by subjecting the carbon particles to the surface treatment with the above-described polymer. For example, the ratio of the arithmetic average roughness Ra (μm) of the composite coating of the composite material of the present invention obtained by the above-described production method to the thickness (μm) of the composite coating (Ra/thickness of composite coating) is less than 0.2. The inventors have found through their studies that the ratio (Ra/thickness of composite coating) is a more effective indicator of the ease with which silver sheds from the composite coating during bending than Ra itself. From the viewpoint of suppressing the shedding of silver from the composite coating during bending, the ratio (Ra/thickness of the composite coating) is preferably 0.18 or less, more preferably 0.16 or less. It is difficult to set the ratio to 0, and the ratio is usually 0.02 or more.

The arithmetic average roughness Ra of the composite coating of the composite material of the present invention is preferably 1.8 μm or less, and more preferably 0.08 to 1.5 μm.

### <2-2-4. Carbon Content and Area Ratio of Carbon Particles>

The composite coating according to the embodiment of the composite material of the present invention contains carbon particles as described above, and from the viewpoint of the wear resistance and electrical conductivity of the composite material, a carbon content in the composite coating is preferably 1 to 50 mass %, more preferably 1.5 to 40 mass %, and even more preferably 2 to 35 mass %. Further, an elemental composition of the composite coating according to the embodiment of the composite material of the present invention typically consists essentially of silver and carbon. As explained in the description of the method for producing a composite material of the present invention, carbon particles that are merely adhered to the surface of the composite coating may be present and are likely to shed. In this case, the carbon content in the composite coating is determined after performing ultrasonic cleaning treatment similar to that explained in the section <<1-5. Treatment for partially removing carbon particles from the surface of the composite coating>>.

Further, the proportion (area ratio) of the carbon particles on the surface of the composite coating containing carbon particles is an indicator of the wear resistance, and a certain degree or higher proportion is necessary from the viewpoint of the wear resistance. On the other hand, when the proportion is too high, there is a problem in terms of electrical conductivity. From the viewpoint of the balance between the wear resistance and the electrical conductivity, the area ratio is 5 area % or more and 80 area % or less, preferably 8 area % or more and 60 area % or less, more preferably 10 area % or more and 50 area % or less, and further preferably 22 area % or more and 40 area % or less. When there are carbon particles on the surface of the composite coating that are easy to shed, the area ratio of carbon on the surface of the composite coating is calculated after subjecting the composite coating to ultrasonic cleaning treatment similar to that described in the section <<1-5. Treatment for partially removing carbon particles from the surface of the composite coating>>. The method for measuring the area ratio will be described in detail in the Examples.

### <2-2-5. Thickness of Composite Coating>

The thickness of the composite coating is not particularly limited, but it is preferable that the thickness be equal to or more than a minimum value in terms of the wear resistance and the electrical conductivity. Further, if the thickness is too large, the effect of the composite coating becomes saturated and a raw material cost increases. From the above viewpoint, the thickness of the composite coating is preferably 0.5 μm or more and 45 μm or less, more preferably 0.5 μm or more and 35 μm or less, and even more preferably 0.5 μm or more and 15 μm or less. Details of the method for measuring the thickness of the composite coating will be described in the Examples. Generally, in plating using the silver plating solution containing carbon particles (AgC plating), if the formed plating film is thin, the carbon particles are difficult to be included in the film. However, in the method for producing a composite material of the present invention, the carbon particles subjected to surface treatment with cationic polymer are used, although a mechanism is unclear, it is possible to form a plating layer (composite coating) that contains sufficient carbon particles even when the plating film is thin (specifically, 0.5 to 2 μm, preferably 0.8 to 1.5 μm). The composite material having such a thin composite coating has an advantage in terms of a raw material cost.

### <<2-3. Underlayer>>

An underlayer may be formed between the base material and the composite coating for various purposes. Constituent metals of the underlayer include Cu, Ni, Sn and Ag. For example, in order to prevent copper in the base material from diffusing through to the surface of the composite coating, which would deteriorate contact reliability, it is preferable to form the underlayer composed of Ni. When the base material is a copper alloy containing zinc, such as brass, it is preferable to form an underlayer composed of Cu in order to prevent the zinc in the base material from diffusing through to the surface of the composite coating. For the purpose of improving the adhesion of the composite coating to the base material, it is preferable to form an underlayer composed of Ag. Although the thickness of the underlayer is not particularly limited, the thickness is preferably 0.1 to 2 μm, and more preferably 0.2 to 1.5 μm from the viewpoints of functionality and cost. Further, the terminals of electrical and electronic components are often made of materials that have been subjected to Sn plating or reflow Sn plating including Cu base or Ni base (layered structure of Cu base, Ni base, and Sn base from the base material side), and in the present invention, an underlayer having such a layered structure may also be formed. Accordingly, in the present invention, the base of the composite coating may include a layer composed of Cu, Ni, Sn, or Ag, or a layer of a combination of these (a layered structure). Also, different layers may be formed depending on a location, such as forming a composite coating as defined in the present invention on an electrical contact part of the base material (the underlayer may or may not be formed) and forming a reflow Sn plating underlayer on an electric wire crimping portion (the composite film is not formed).

<<2-4. Shedding of Silver from the Composite Coating During Bending>>

As described above, according to the embodiment of the composite material of the present invention, the ratio (Ra/thickness of the composite coating) is as small as less than 0.2, and silver is prevented from shedding from the composite coating during bending. Specifically, in a test for evaluating silver shedding during bending in the examples described below, a peeled carbon tape was subjected to EDS analysis using an energy dispersive X-ray analyzer, in which the proportion of Ag is preferably 15% by mass or less, more preferably 10% by mass or less, further preferably 7% by mass or less, and particularly preferably 4% by mass or less, when the total of detected Ag, C, O and Cu is taken as 100 mass %. It is difficult to reduce the proportion of Ag to 0, and it is usually 0.2 mass % or more.

### <<2-5. Coefficient of Friction>>

Further, as described above, according to an embodiment, the composite material of the present invention has the composite coating containing carbon particles, with the crystallite size of the coating being 30 nm or less, and the proportion of the carbon particles on the surface of the coating being 5 area % or more and 80 area % or less, thus exhibiting excellent wear resistance. Specifically, the friction coefficient of the composite material, measured by the method in the examples described below, is preferably 0.4 or less, more preferably 0.3 or less, and even more preferably 0.24 or less. It is difficult to reduce the friction coefficient to 0, and it is usually 0.05 or more.

### [3. Terminals]

The composite material according to the embodiment of the present invention has excellent wear resistance and is less susceptible to silver shedding from the composite coating during bending, and therefore is suitable as a constituent material for a terminal for an electrical contact part, particularly a terminal (produced by bending) in an electrical contact part such as a switch and connector that undergo sliding during use.

### EXAMPLES

Examples of a composite plated material and a method for producing the same according to the present invention will be described in detail hereafter.

### (Example 1) [1. Production of the Composite Coating]

### <1-1. Preparation of the Carbon Particles>

### (1-1-1. Oxidation Treatment)

80 g of flaky-shaped graphite particles (PAG-3000 manufactured by Nippon Graphite Industries Co., Ltd.) having an average particle size of 5 μm as carbon particles were added to 1.4 L of pure water, and the mixture was heated to 50° C. with stirring. An average particle size is a particle size at which a cumulative value on a volume basis is 50%, measured using a laser diffraction/scattering type particle size distribution measuring device (Microtrac Bell MT3300 (LOW-WET MT3000II Mode)). Next, 5.2 g of potassium hydroxide was added to this mixture, and then 0.6 L of a 0.1 mol/L aqueous potassium persulfate solution was slowly added dropwise as an oxidizing agent, and a mixture was stirred for 1 hour to perform an oxidation treatment, followed by filtering through a filter paper, and a solid matter thus obtained was washed with water.

### (1-1-2. Evaluation of Hydrocarbon Compound Removal by Oxidation Treatment)

The carbon particles before and after the oxidation treatment were analyzed for the gas generated when heated to 300° C., using a purge and trap gas chromatograph mass spectrometer (a thermal desorption device that is a JHS-100 manufactured by Japan Analytical Industry Co., Ltd., and a gas chromatograph mass spectrometer that is a GCMS QP-5050A manufactured by Shimadzu Corporation.). Then, it was found that due to the oxidation treatment, lipophilic aliphatic hydrocarbons (such as nonane, decane, and 3-methyl-2-heptene) and lipophilic aromatic hydrocarbons (such as xylene) that were adhered to the carbon particles, were removed.

### (1-1-3. Surface Treatment)

After adding 60 g of the carbon particles after the above oxidation treatment to 0.6 L of pure water, 100 g of poly(diallyldimethylammonium chloride) aqueous solution (weight average molecular weight: 1600, number average molecular weight: 1500) (Unisense FPA100L manufactured by Senka Corporation, poly(diallyldimethylammonium chloride) concentration is 25 to 35% by mass) was added and the mixture was stirred and mixed at a liquid temperature of 25° C. for 24 hours to perform a surface treatment of the carbon particles, followed by filtering through a filter paper, and the solid matter thus obtained was washed with water until the electrical conductivity of a filtrate reached 10 μS/cm. An average molecular weight was measured by GPC (gel permeation chromatography) under the following conditions.

Eluent: Water (containing sodium nitrate at a concentration of 0.1 mol/L and acetic acid at a concentration of 0.5 mol/L)

Standard substance: A mixture of polyethylene oxide (standard substance for molecular weights of 10,000 or more) and polyethylene glycol (standard substance for molecular weights of less than 10,000)

Sample concentration: 0.2 w/v %

Injection volume: 100 μL

Flow rate: 1.0 mL/min

Column: Shodex OHpak SB-806M HQ×2 (Showa Denko K.K.)

Column temperature: 40° C.

Pump: LC-10ADvp (Shimadzu Corporation)

Detector: Shodex RI-71 (Showa Denko K.K.)

### <1-2. Silver Strike Plating>

A plate material was prepared, which was composed of a Cu—Ni—Sn—P alloy (a copper alloy plate material containing 1.0 mass % Ni, 0.9 mass % Sn, 0.05 mass % P, with a remainder being Cu and unavoidable impurities) (NB-109EH manufactured by DOWA Metaltech Co., Ltd.) measuring 5.0 cm in length, 5.0 cm in width, and 0.2 mm in thickness. With this plate material used as a base material, and using this base material as a cathode and an iridium oxide mesh electrode plate (a titanium mesh material coated with iridium oxide) as an anode, electroplating (silver strike plating) was performed at a current density of 5 A/dm² for 60 seconds, in a sulfonic acid-based silver strike plating solution (Dain Silver GPE-ST manufactured by Daiwa Kasei Co., Ltd., substantially free of cyanide compounds, silver concentration 3 g/L, methanesulfonic acid concentration 42 g/L) containing methanesulfonic acid as a complexing agent. The silver strike plating was applied to an entire surface of the base material.

### <1-3. AgC Plating>

The above-described surface-treated carbon particles (graphite particles) were added to a sulfonic acid-based silver plating solution (Dain Silver GPE-HB manufactured by Daiwa Kasei Co., Ltd. (containing compound A corresponding to general formula (I) at a concentration of 4.2 g/L, and a solvent is mainly water)) containing methanesulfonic acid as a complexing agent and having a silver concentration of 30 g/L and a methanesulfonic acid concentration of 60 g/L, to prepare a carbon particle-containing sulfonic acid-based silver plating solution containing carbon particles at a concentration of 50 g/L, silver at a concentration of 30 g/L, and methanesulfonic acid at a concentration of 60 g/L. This silver plating solution is substantially free of cyanide compounds.

Next, with a silver strike plated base material used as a cathode and a silver electrode plate used as an anode, electroplating is performed in the carbon particle-containing sulfonic acid-based silver plating solution at a temperature of 25° C. and a current density of 3 A/dm² for 300 seconds while stirring with a stirrer at 400 rpm, to obtain a composite material in which a composite coating (AgC plating coating) containing carbon particles in a silver layer was provided on the base material. The composite coating was formed on an entire surface of the base material.

### <1-4. Ultrasonic Cleaning Treatment>

The surface of the composite coating of the obtained composite material was subjected to ultrasonic cleaning treatment at 28 kHz for 4 minutes using an ultrasonic cleaner (VS-100III manufactured by AS ONE, output 100 W, tank interior dimensions: length 140 mm×width 240 mm×depth 100 mm, liquid medium: water).

### [2. Evaluation of the Composite Material]

The composite material obtained in Example 1 was evaluated as follows.

### <2-1. Thickness of the Composite Coating>

The thickness of a circular area with a diameter of 0.2 mm at the center of the 5.0 cm×5.0 cm surface of the composite coating of the composite material, was measured with a fluorescent X-ray thickness gauge (FT110A manufactured by Hitachi High-Tech Science Corporation) and found to be 5 μm. It is difficult to detect C atoms (of carbon particles) with a fluorescent X-ray thickness gauge, so the thickness is determined by detecting Ag atoms, and in the present invention, the thickness determined in this manner is regarded as the thickness of the composite coating.

### <2-2. Vickers Hardness Hv of a Composite Coating Surface>

The Vickers hardness Hv of the above composite coating surface was measured in accordance with JIS Z2244 using a microhardness tester (HM221 manufactured by Mitutoyo Corporation) by applying a load of 0.01 N to a flat part of the composite material for 15 seconds, and an average value of three measurements was used. As a result, the Vickers hardness was 154 Hv.

### <2-3. Carbon Area Ratio of the Composite Coating Surface>

The composite coating surface was observed using a tabletop microscope (TM4000 Plus manufactured by Hitachi High-Tech Corporation) at an accelerating voltage of 5 kV and a magnification of 1000 times, to obtain a backscattered electron composition (COMPO) image (1 field of view), and it was binarized using GIMP 2.10.10 (image analysis software), and the area ratio of carbon to the composite coating surface was calculated. Specifically, when the highest brightness of all pixels is set to 255, and the lowest brightness is set to 0, a gradation is binarized so that pixels with a brightness of 127 or less are black, and pixels with a brightness of more than 127 are white, and an image was separated into a silver portion (white portion) and a carbon particle portion (black portion), and the ratio Y/X of the number Y of pixels in the carbon particle portion to the number X of pixels in an entire image was calculated as a carbon area ratio (%) in the surface. As a result, the carbon area ratio after ultrasonic cleaning treatment was 26%. An observation range using the tabletop microscope was 88 μm in length and 127 μm in width, with one pixel being 0.1 μm square (880 pixels in length, 1270 pixels in width, a total of 1,117,600 pixels), and image processing was performed using GIMP 2.10.10.

### <2-4. Crystallite Size of Silver of the Composite Coating>

X-ray diffraction measurements (Cu Kα ray tube, tube voltage: 30 kV, tube current: 10 mA, step width: 0.02°, scanning range: 2θ=10° to 154°, scanning speed: 10°/min, measurement time: about 15 minutes, (111) plane peak: 2θ=37.9 to 38.7°, (222) plane peak: 2θ=79 to) 82.2° were performed to the surface of the above composite coating using an X-ray diffraction apparatus (D2Phaser 2nd Generation manufactured by Bruker Japan Ltd.) in accordance with JIS H7805:2005. From the detected peaks of the silver (111) and (222) planes, a full width at half maximum (FWHM) was determined using X-ray analysis software (PDXL manufactured by Rigaku Corporation), and the crystallite size in each silver crystal plane was calculated using Scherrer's formula. In order to reduce bias due to a crystal plane, an average value of the crystallite sizes of the (111) and (222) planes of silver was taken as a crystallite size of silver. The crystallite size was 13 nm.

The Scherrer formula is as follows:
D=K λ/(β cos θ)
D: crystallite size
K: Scherrer constant, set to 0.9
λ: X-ray wavelength, 1.54 Å for CuKα radiation
B: full width at half maximum (FWHM) (rad)
θ: measurement angle (deg)

### <2-5. Arithmetic Average Roughness of the Composite Coating/Thickness of the Composite Coating>

The surface of the above composite coating was photographed at a magnification of 1000 times using a laser microscope (VKX-110 manufactured by Keyence Corporation), and the arithmetic average roughness Ra, a parameter that represents a surface roughness (over an entire observed surface of the composite coating), was calculated using an analysis application (Keyence Corporation VK-HIXA version 3.8.0.0) based on JIS B0601:2001, to obtain a value of 0.70 μm. Then, an arithmetic average roughness Ra was divided by the thickness of the composite coating measured above, to obtain a value of 0.14.

### <2-6. Measurement of a Friction Coefficient>

The same Cu—Ni—Sn—P alloy plate material as used in Example 1 was subjected to an indentation treatment (extrusion into a hemispherical shape) with an inner diameter of 1.0 mm, and was subjected to a plating treatment (AgSb plating) similar to that of Comparative example 1 described below, to obtain an indent test piece.

On the other hand, a plate-shaped composite coating material obtained in Example 1 was used as a plate test piece, and the indent test piece was pressed against the plate test piece with a constant load (5N) in a sliding wear tester (Yamazaki Seiki Laboratory Co., Ltd. CRS-G2050-DWA) so that a convex part of the indent test piece (the surface of which is AgSb plated.) was in contact with the composite coating surface of the plate test piece, while sliding the indent test piece at a sliding speed of 0.4 mm/sec, and the sliding load was measured from the start of sliding until a sliding distance of 5 mm. The sliding load data for the sliding distance between 2 mm and 3 mm was averaged to determine a friction coefficient (average sliding load F/5N), and a value of 0.16 was obtained.

### <2-7. Evaluation Test for Silver Shedding During Bending>

A bending test piece with a width of 10 mm was cut out from the obtained composite material so that a longitudinal direction was TD (direction perpendicular to a rolling direction) and a width direction was LD (the rolling direction), and a 90° W bending test in accordance with JIS H3130 was performed to the bending test piece with the LD set as a bending axis (Bad Way bending (B. W. Bending)) and a bending radius set as R=0.2 mm.

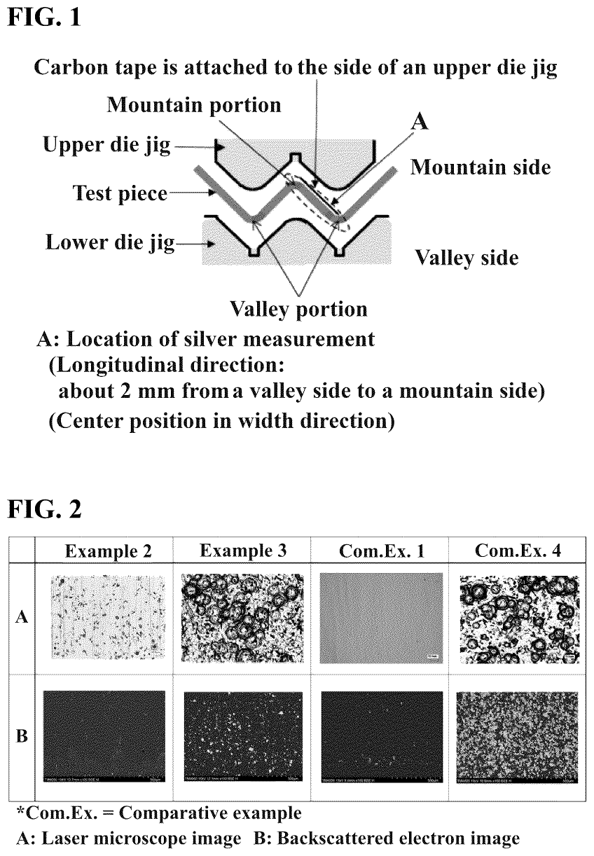

The above 90° W bending test will be described with reference to FIG. 1. FIG. 1 is a schematic cross-sectional view showing a test piece in which peaks and valleys are formed by being sandwiched between an upper die jig and a lower die jig. When the test piece was sandwiched between the upper and lower die jigs and bent, a load applied to the upper and lower die jigs was monitored to prevent the upper and lower die jigs from applying additional load to the bent test piece.

After this test, peeling, that is, sticking the tape and then peeling it off was performed to the surface of the test piece that came into contact with the upper die jig, using a carbon tape (Nisshin EM Co., Ltd. carbon double-sided tape 7322 for SEM: width 12 mm). The carbon tape was stuck so that it protruded 1 mm on both sides in a width direction of the test piece.

After peeling, on the surface of the carbon tape having been in contact with the upper die jig of the test piece, observation was performed on a position which is 2 mm in a longitudinal direction toward the center position in the width direction corresponding to the bent portion that becomes the peak from a center position in a width direction corresponding to the bent part that becomes the valley portion of the test piece, at a magnification of 100 times using a tabletop electron microscope (TM4000 Plus manufactured by Hitachi High-Technologies Corporation) with an accelerating voltage of 15 kV.

Then, an EDS analysis was performed to an observation area (one field of view) of this carbon tape using an energy dispersive X-ray analyzer (AztecOne manufactured by Oxford Instruments) attached to the above-described tabletop microscope. As a result, C, O and Ag were detected, and an amount of Ag in these sums was 0.90% by weight. In this specification, this value is used as an indicator of silver shedding during bending.

### (Example 2) [1. Production of the Composite Material]

A composite material according to Example 2 was produced in the same manner as in Example 1, except that the electroplating time as explained in the section <1-3. AgC plating> of Example 1 was set to 60 seconds. This composite material was evaluated in the same manner as in Example 1. Further, FIG. 2 shows a laser microscope photograph (magnification: 1000 times) of this composite material observed, and a backscattered electron image photograph (magnification: 1000 times) of silver in the carbon tape after peeling performed in <2-7. Evaluation test for silver shedding during bending>, in the same manner as in Example 1.

### (Example 3) [1. Production of the Composite Material]

A composite material according to Example 3 was produced in the same manner as in Example 1, except that the electroplating time as explained in the section <1-3. AgC plating> of Example 1 was set to 900 seconds. This composite material was evaluated in the same manner as in Example 1.

Further, FIG. 2 shows a laser microscope photograph (magnification: 1000 times) of this composite material, and a backscattered electron image photograph (magnification: 1000 times) of silver in the carbon tape after peeling performed in <2-7. Evaluation test for silver shedding during bending>, observed in the same manner as in Example 1.

### (Example 4) [1. Production of the Composite Material]

A composite material according to Example 4 was produced by performing the same operation as in Example 1, except that nickel plating was performed as an underlayer before <1-2. Silver strike plating>, to the base material (a plate material composed of a Cu—Ni—Sn—P alloy having a length of 5.0 cm, a width of 5.0 cm, and a thickness of 0.2 mm) as explained in Example 1.

Specifically, using the plate material as explained in Example 1 as a base material, and with this base material used as a cathode and a Ni electrode plate used as an anode, the nickel plating was performed by electroplating at a current density of 4 A/dm² for 60 seconds, in a sulfamic acid bath (nickel concentration 80 g/L, boric acid concentration 45 g/L). Nickel plating was applied to an entire surface of the base material.

The composite material obtained in Example 4 was evaluated in the same manner as in Example 1.

### (Example 5) [1. Production of Composite Material]

A composite material according to Example 5 was produced in the same manner as in Example 1, except that poly(diallyldimethylammonium chloride) aqueous solution having a weight average molecular weight of 20,000 (number average molecular weight: 6,300) (concentration: 35 to 45% by mass, Unisense FPA102L manufactured by Senka Corporation), was used as the poly(diallyldimethylammonium chloride) aqueous solution as explained in (1-1-3. Surface treatment) of the section <1-1. Production of carbon particles> of Example 1. This composite material was evaluated in the same manner as in Example 1.

### (Example 6) [1. Production of Composite Material]

A composite material according to Example 6 was produced in the same manner as in Example 1, except that poly(diallyldimethylammonium chloride) aqueous solution having a weight average molecular weight of 64,000 (number average molecular weight: 11,000) (concentration: 40 to 50% by mass, Unisense FPA1000L manufactured by Senka Corporation), was used as the poly(diallyldimethylammonium chloride) aqueous solution as explained in (1-1-3. Surface treatment) of the section <1-1. Preparation of carbon particles> of Example 1. This composite material was evaluated in the same manner as in Example 1.

### (Example 7) [1. Production of the Composite Material]

A composite material according to Example 7 was produced in the same manner as in Example 1, except that the poly(diallyldimethylammonium chloride) aqueous solution as explained in (1-1-3. Surface treatment) of the section <1-1. Production of carbon particles> of Example 1, was changed to a diallylamine hydrochloride-acrylamide copolymer aqueous solution (Unisense KCA100L manufactured by Senka Corporation, the weight average molecular weight of the copolymer is 16,000, the number average molecular weight is 4,000, and the concentration of the copolymer is 20 to 25% by mass). This composite material was evaluated in the same manner as in Example 1.

### (Example 8) [1. Production of the Composite Material]

A composite material according to Example 8 was produced in the same manner as in Example 1, except that AX-14S manufactured by Senka Corporation was used instead of the Unisense FPA100L manufactured by Senka Corporation as explained in (1-1-3. Surface treatment) of the section <1-1. Production of carbon particles> of Example 1. This composite material was evaluated in the same manner as in Example 1. AX-14S is a chemical agent whose main component is a polyhydric phenol condensate derivative with a weight-average molecular weight of approximately 3,000 (nominal value stated by the manufacturer). The polyhydric phenol condensate derivative has a hydroxyl group and a sulfo group.

### (Example 9) [1. Production of the Composite Material]

A composite material according to Example 9 was produced in the same manner as in Example 8, except that the electroplating time in the AgC plating of Example 8 (referred to as <1-3. AgC plating> in Example 1) was set to 600 seconds. This composite material was evaluated in the same manner as in Example 1.

### (Example 10) [1. Production of the Composite Material]

A composite material according to Example 10 was produced in the same manner as in Example 1, except that Unisense EFH-06 manufactured by Senka Corporation was used instead of the Unisense FPA100L manufactured by Senka Corporation as explained in the section (1-1-3. Surface treatment) of <1-1. Production of carbon particles> of Example 1. EFH-06 is a chemical agent whose main component is polyacrylamide with a weight-average molecular weight of hundreds of thousands to several millions (nominal value stated by the manufacturer).

### (Comparative Example 1) [1. Production of the Composite Material]

In the same manner as in Example 1, a composite material according to Comparative Example 1 in which a composite coating composed of an AgSb alloy is provided on a base material was produced, except that a cyanide-based Ag—Sb alloy plating solution (solvent: water) containing a cyanide compound as a complexing agent and having a silver concentration of 60 g/L and an antimony (Sb) concentration of 2.5 g/L was used instead of the sulfonic acid-based silver plating solution used in <1-3. AgC plating> of Example 1, electroplating was performed for 2400 seconds at a current density of 1 A/dm², and ultrasonic cleaning was not performed.

The cyan-based Ag—Sb alloy plating solution contains 10% by mass of silver cyanide, 30% by mass of sodium cyanide, and Nissin Bright N (manufactured by Nissin Chemical Industries, Ltd.), in which the concentration of the Nissin Bright N in the plating solution is 50 mL/L. The Nissin Bright N contains a brightener and diantimony trioxide, and the concentration of the diantimony trioxide in the Nissin Bright N is 6 mass %.

The composite material of Comparative Example 1 obtained above was evaluated in the same manner as in Example 1. Further, FIG. 2 shows a laser microscope photograph (magnification: 1000 times) of this composite material observed, and a backscattered electron image photograph (magnification: 1000 times) of silver in the carbon tape after peeling performed in <2-7. Evaluation test for silver shedding during bending>, in the same manner as in Example 1.

### (Comparative Example 2) [1. Production of the Composite Material]

A composite material according to Comparative Example 2 was produced in the same manner as in Example 1, except that the (1-1-3. Surface treatment) as explained in the section <1-1. Production of carbon particles> of Example 1 was not performed. This composite material was evaluated in the same manner as in Example 1.

### (Comparative Example 3) [1. Production of the Composite Material]

A composite material according to Comparative Example 3 was produced in the same manner as in Example 1, except that the (1-1-3. Surface treatment) as explained in the section <1-1. Production of carbon particles> of Example 1 was not performed, and the electroplating time as explained in the section <1-3. AgC plating> of Example 1 was set to 600 seconds. This composite material was evaluated in the same manner as in Example 1.

### (Comparative Example 4) [1. Production of the Composite Material]

A composite material according to Comparative Example 4 was produced in the same manner as in Example 1, except that the poly(diallyldimethylammonium chloride) aqueous solution as explained in (1-1-3. Surface treatment) of the section <1-1. Production of carbon particles> of Example 1 was changed to a 65 mass % diallyldimethylammonium chloride (molecular weight 162) aqueous solution, and the electroplating time as explained in the section <1-3. AgC plating> of Example 1, was changed to 600 seconds. This composite material was evaluated in the same manner as in Example 1. Further, FIG. 2 shows a laser microscope photograph (magnification: 1000 times) of this composite material, and a backscattered electron image photograph (magnification: 1000 times) of silver in the carbon tape after peeling performed in <2-7. Evaluation test for silver shedding during bending>, observed in the same manner as in Example 1.

### (Comparative Example 5) [1. Production of the Composite Material]

A composite material according to Comparative Example 5 was produced in the same manner as in Example 1, except that the (1-1-3. Surface treatment) as explained in the section <1-1. Production of carbon particles> of Example 1 was not performed, and the electroplating time as explained in the section <1-3. AgC plating> of Example 1 was set to 60 seconds. This composite material was evaluated in the same manner as in Example 1.

Production conditions for the composite materials of Examples 1 to 7 are shown in Table 1, and various evaluation results are shown in Table 2, production conditions for the composite materials of Examples 8 to 10 are shown in Table 3, various evaluation results are shown in Table 4, production conditions for the composite materials of Comparative Examples 1 to 5 are shown in Table 5, and various evaluation results are shown in Table 6.

TABLE 1

| | | | Example 1 | Example 2 | Example 3 | Example 4 | Example 5 | Example 6 | Example 7 |
|---|---|---|---|---|---|---|---|---|---|
| With or without oxidation of carbon particles | | | With | With | With | With | With | With | With |
| Surface | Polymer | | B | B | B | B | B | B | Diallylamine |
| treatment | | | | | | | | | hydrochloride- |
| of carbon | | | | | | | | | acrylamide |
| particles | | | | | | | | | copolymer |
| with | Cationic/anionic/nonionic | | Cationic | Catonic | Cationic | Cationic | Cationic | Cationic | Cationic |
| polymer | Molecular weight | | 1600 | 1600 | 1600 | 1600 | 20000 | 64000 | 16000 |
| | (weight average molecular weight) | | | | | | | | |
| Underlayer | Plating | Ni concentration (g/L) | — | — | — | 80 | — | — | — |
| | solution | Boric acid concentration (g/L) | — | — | — | 45 | — | — | — |
| | Plating | Current density (A/dm²) | — | — | — | 4 | — | — | — |
| | condition | Treatment time (s) | — | — | — | 60 | — | — | — |
| With or without Ag strike plating | | | With | With | With | With | With | With | With |
| AgC | Plating | Presence or absence | Present | Present | Present | Present | Present | Present | Present |
| plating | solution | of compound A | | | | | | | |
| | | Ag concentration (g/L) | 30 | 30 | 30 | 30 | 30 | 30 | 30 |
| | | Complexing agent | 60 | 60 | 60 | 60 | 60 | 60 | 60 |
| | | concentration (g/L) | Methane- | Methane- | Methane- | Methane- | Methane- | Methane- | Methane- |
| | | | sulfonic | sulfonic | sulfonic | sulfonic | sulfonic | sulfonic | sulfonic |
| | | | acid | acid | acid | acid | acid | acid | acid |
| | | C concentration (g/L) | 50 | 50 | 50 | 50 | 50 | 50 | 50 |
| | Plating | Current density (A/dm²) | 3 | 3 | 3 | 3 | 3 | 3 | 3 |
| | condition | Stirring speed (rpm) | 400 | 400 | 400 | 400 | 400 | 400 | 400 |
| | | Treatment time (s) | 300 | 60 | 900 | 300 | 300 | 300 | 300 |

| | | | | | | | |
|---|---|---|---|---|---|---|---|
| With or without ultrasonic cleaning treatment | With | With | With | With | With | With | With |

B: Poly (diallyldimethylammonium chloride)

TABLE 2

| | Example 1 | Example 2 | Example 3 | Example 4 | Example 5 | Example 6 | Example 7 |
|---|---|---|---|---|---|---|---|
| Composite coating thickness (μm) | 5 | 1 | 15 | 5 | 5 | 5 | 5 |
| Arithmetic average roughness Ra (μm) | 0.70 | 0.10 | 1.50 | 0.70 | 0.30 | 0.20 | 0.40 |
| Ratio | 0.14 | 0.10 | 0.10 | 0.14 | 0.06 | 0.04 | 0.08 |
| (Ra/composition coating thickness) | | | | | | | |
| Crystallite size (nm) | 13 | 16 | 14 | 13 | 17 | 17 | 15 |
| Ni underlayer thickness (μm) | — | — | — | 1 | — | — | — |
| C area ratio (%) | 26 | 15 | 19 | 26 | 12 | 8 | 12 |
| Vickers hardness (Hv) | 154 | 155 | 165 | 154 | 158 | 163 | 166 |
| Coefficient of friction | 0.16 | 0.25 | 0.25 | 0.16 | 0.24 | 0.28 | 0.21 |
| Value of the indicator of silver shedding | 0.90 | 0.40 | 5.20 | 0.90 | 1.90 | 3.01 | 9.50 |
| during processing (weight percent) | | | | | | | |

TABLE 3

| | | | Example 8 | Example 9 | Example 10 |
|---|---|---|---|---|---|
| With or without oxidation of carbon particles | | | With | With | With |
| Surface | Polymer | | Polyhydric | Polyhydric | Polyacrylamide |
| treatment | | | phenol | phenol | |
| of carbon | | | condensate | condensate | |
| particles | | | derivative | derivative | |
| with polymer | Cationic/anionic/nonionic | | anionic | anionic | nonionic |
| | Molecular weight | | 3000 | 3000 | Hundreds of |
| | (weight average molecular weight) | | | | thousands to |
| | | | | | several millions |
| Underlayer | Plating | Ni concentration (g/L) | — | — | — |
| | solution | Boric acid concentration (g/L) | — | — | — |
| | Plating | Current density (A/dm²) | — | — | — |
| | condition | Treatment time (s) | — | — | — |
| With or without Ag strike plating | | | With | With | With |
| AgC | Plating | Presence or absence | Present | Present | Present |
| plating | solution | of compound A | | | |
| | | Ag concentration (g/L) | 30 | 30 | 30 |
| | | Complexing agent | 60 | 60 | 60 |
| | | concentration (g/L) | Methane- | Methane- | Methane- |
| | | | sulfonic | sulfonic | sulfonic |
| | | | acid | acid | acid |
| | | C concentration (g/L) | 50 | 50 | 50 |
| | Plating | Current density (A/dm²) | 3 | 3 | 3 |
| | condition | Stirring speed (rpm) | 400 | 400 | 400 |
| | | Treatment time (s) | 300 | 600 | 300 |

| | | | |
|---|---|---|---|
| With or without ultrasonic cleaning treatment | With | With | With |

TABLE 4

| | Example | Example | Example |
|---|---|---|---|
| | 8 | 9 | 10 |
| Composite coating thickness (μm) | 5 | 10 | 5 |
| Arithmetic average roughness | 0.4 | 0.8 | 0.7 |
| Ra (μm) | | | |
| Ratio | 0.1 | 0.1 | 0.1 |
| (Ra/composition coating thickness) | | | |
| Crystallite size (nm) | 17 | 17 | 16 |
| Ni underlayer thickness (μm) | — | — | — |
| C area ratio (%) | 22 | 23 | 16 |
| Vickers hardness (Hv) | 164 | 164 | 162 |
| Coefficient of friction | 0.27 | 0.26 | 0.24 |
| Value of the indicator | 1.7 | 6.4 | 3.3 |
| of silver shedding during | | | |
| processing (weight percent) | | | |

TABLE 5

| | | | Comparative | Comparative | Comparative | Comparative | Comparative |
|---|---|---|---|---|---|---|---|
| | | | example 1 | example 2 | example 3 | example 4 | example 5 |
| With or without oxidation of carbon particles | | | — | With | With | With | With |
| Surface | Cationic compound | | — | — | — | Diallyl- | — |
| treatment | | | | | | dimethyl- | |
| of carbon | | | | | | ammonium | |
| particles | | | | | | chloride | |
| with cationic | | | | | | (monomer) | |
| compound | Molecular weight | | — | — | — | 162 | — |
| Underlayer | Plating | Ni concentration (g/L) | — | — | — | — | — |
| | solution | Boric acid concentration (g/L) | — | — | — | — | — |
| | Plating | Current density (A/dm²) | — | — | — | — | — |
| | condition | Treatment time (s) | — | — | — | — | — |
| With or without Ag strike plating | | | With | With | With | With | With |
| Ag-based | Plating | Presence or absence | Absent | Present | Present | Present | Present |
| plating | solution | of compound A | | | | | |
| | | Ag concentration (g/L) | 60 | 30 | 30 | 30 | 30 |
| | | Complexing agent | 300 | 60 | 60 | 60 | 60 |
| | | concentration (g/L) | Sodium | Methane- | Methane- | Methane- | Methane- |
| | | | cyanide | sulfonic | sulfonic | sulfonic | sulfonic |
| | | | | acid | acid | acid | acid |
| | | C concentration (g/L) | 0 | 50 | 50 | 50 | 50 |
| | Plating | Current density (A/dm²) | 1 | 3 | 3 | 3 | 3 |
| | condition | Stirring speed (rpm) | 400 | 400 | 400 | 400 | 400 |
| | | Treatment lime (s) | 2400 | 300 | 800 | 800 | 80 |

| | | | | | |
|---|---|---|---|---|---|
| With or without ultrasonic cleaning treatment | Without | With | With | With | With |

TABLE 6

| | Comparative | Comparative | Comparative | Comparative | Comparative |
|---|---|---|---|---|---|
| | example 1 | example 2 | example 3 | example 4 | example 5 |
| Composite coating thickness (μm) | 10 | 5 | 10 | 10 | 1 |
| Arithmetic average roughness Ra (μm) | 0.10 | 1.20 | 2.20 | 2.00 | 0.10 |
| Ratio | 0.01 | 0.24 | 0.22 | 0.20 | 0.10 |
| (Ra/composition coating thickness) | | | | | |
| Crystallite size (nm) | 24 | 11 | 11 | 14 | 16 |
| Ni underlayer thickness (μm) | — | — | — | — | — |
| C area ratio (%) | 0 | 14 | 26 | 18 | 2 |
| Vickers hardness (Hv) | 187 | 161 | 157 | 154 | 155 |
| Coefficient of friction | 1.00 | 0.14 | 0.32 | 0.31 | 0.95 |
| Value of the indicator of silver shedding | 0.80 | 21.40 | 38.20 | 33.70 | 0.40 |
| during processing (weight percent) | | | | | |

1. A composite material, that is a composite material in which a composite coating composed of a silver layer containing carbon particles is provided on a base material,
wherein a crystallite size of silver of the composite coating is 30 nm or less;
a value obtained by dividing an arithmetic average roughness Ra (μm) of the composite coating by a thickness (μm) of the composite coating is less than 0.2; and
a proportion of the carbon particles on a surface of the composite coating is 5% by area or more and 80% by area or less.

2. The composite material according to claim 1, wherein the base material is composed of Cu or a Cu alloy.

3. The composite material according to claim 1, wherein the surface of the composite coating has a Vickers hardness of 100 or more.

4. The composite material according to claim 1, wherein the thickness of the composite coating is 0.5 μm or more and 45 μm or less.

5. The composite material according to claim 1, wherein the composite coating has an arithmetic average roughness Ra of 1.8 μm or less.

6. The composite material according to claim 1, wherein a crystallite size of silver of the composite coating is 2 to 20 nm.

7. The composite material according to claim 1, wherein an underlayer selected from Cu, Ni, Sn, and Ag is provided between the base material and the composite coating.

8. A method for producing a composite material, comprising:
electroplating in a silver plating solution containing carbon particles to form a composite coating composed of a silver layer containing the carbon particles on a base material,
wherein the carbon particles are surface-treated with a polymer, and
the silver plating solution contains the surface-treated carbon particles and a compound A represented by the following general formula (I),
[Chemical formula 1] 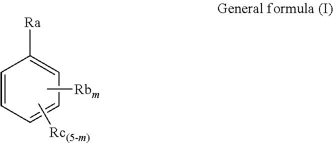
(in the general formula (I), m is an integer from 1 to 5;
Ra is a carboxyl group;
Rb is an aldehyde group, a carboxyl group, an amino group, a hydroxyl group, or a sulfonic acid group; and
Rc is hydrogen or an arbitrary substituent;
when m is 2 or more, a plurality of Rb's may be the same or different;
when m is 3 or less, a plurality of Rc's may be the same or different; and
Ra and Rb may each independently be bonded to a benzene ring via a divalent group composed of at least one selected from a group consisting of —O— and —CH₂—).

9. The method for producing a composite material according to claim 8, wherein the polymer is a cationic polymer, an anionic polymer or a nonionic polymer.

10. The method for producing a composite material according to claim 9, wherein the cationic polymer is at least one selected from a group consisting of poly (diallyldimethylammonium chloride) and diallylamine hydrochloride-acrylamide copolymer.

11. The method for producing a composite material according to claim 9, wherein a weight average molecular weight of the cationic polymer is 1,000 or more and 150,000 or less.

12. The method for producing a composite material according to claim 9, wherein the anionic polymer is a polyhydric phenol condensate derivative, and the condensate derivative has a hydroxyl group and a sulfo group.

13. The method for producing a composite material according to claim 9, wherein a weight average molecular weight of the anionic polymer is 1,000 or more and 50,000 or less.

14. The method for producing a composite material according to claim 9, wherein the nonionic polymer is polyacrylamide.

15. The method for producing a composite material according to claim 9, wherein a weight average molecular weight of the nonionic polymer is 1,000 or more and 10,000,000 or less.

16. The method for producing a composite material according to claim 8, wherein an amount of the polymer used per 100 parts by mass of the carbon particles is 10 to 150 parts by mass.

17. The method for producing a composite material according to claim 8, wherein a concentration of the carbon particles in the silver plating solution is 10 g/L or more and 150 g/L or less.

18. The method for producing a composite material according to claim 8, wherein a surface treatment of the carbon particles is performed by stirring and mixing the carbon particles in water in a presence of the polymer.

19. The method for producing a composite material according to claim 8, wherein the base material is composed of Cu or a Cu alloy.

20. A terminal for electrical contacts, the terminal comprising the composite material according to claim 1 as a constituent material.
